(19) United States
(12) Patent Application Publication
(10) Pub. No.: US 2014/0246599 A1
(43) Pub. Date: Sep. 4, 2014

(54) System and Apparatus to Illuminate Individual Particles

(71) Applicants: Matthew B Hart, Silver Spring, MD (US); Patrick M Nolan, Havre de Grace, MD (US); Jay D Eversole, Woodbridge, VA (US)

(72) Inventors: Matthew B Hart, Silver Spring, MD (US); Patrick M Nolan, Havre de Grace, MD (US); Jay D Eversole, Woodbridge, VA (US)

(73) Assignee: The Government of the United States of America, as represented by the Secretary of the Navy, Washington, DC (US)

(21) Appl. No.: 14/082,507

(22) Filed: Nov. 18, 2013

Related U.S. Application Data
(60) Provisional application No. 61/771,246, filed on Mar. 1, 2013.

(51) Int. Cl. H01J 49/02

(52) U.S. Cl. CPC H01J 49/02
USPC 250/372; 250/489; 250/430

(57) ABSTRACT

An apparatus for illuminating individual particles comprising a device for moving and directing air containing particles into a system, the system comprising an electrodynamic linear quadrupole section, an ultra-violet electromagnetic radiation source located along the electrodynamic linear quadrupole section, and a collection device for collecting the particles. A method of illuminating individual particles comprising moving and directing air containing particles into a system, controlling the air flow by using an air pump that continuously pulls or pushes air through the system, directing the particles into an electrodynamic linear quadrupole section, confining the particles to the central axis of the electrodynamic linear quadrupole section, illuminating the particles with ultra-violet electromagnetic radiation, interrogating the particles, and collecting the particles.

### REFERENCE TO RELATED APPLICATION

This application is a non-provisional of, and claims priority to and the benefits of, U.S. Provisional Patent Application No. 61/771,246 filed on Mar. 1, 2013, the entirety of which is hereby incorporated by reference.

### BACKGROUND

One purpose of the present invention is to supply a method, system and apparatus to illuminate small, micron (10⁻⁶ meter) size particles with controlled amounts of ultra-violet electromagnetic radiation and then to collect the particles to interrogate for possible changes, such as the ability of live organisms to survive after the illumination.

The present method, system and apparatus also supply a way to interrogate particles and remove individual particles from the system before collection to provide a filtering of unwanted particles.

### DESCRIPTION

### Particle Confinement

The present invention requires the use of an ambient air, electrodynamic linear quadrupole trap (ELQ) to confine particles. A similar apparatus is described with detail in U.S. Pat. No. 5,532,140, issued in 1996 to Arnold, et. al. The basic elements that make up an ELQ are four conductive posts which are aligned in parallel, in a square configuration. Posts which are diagonally across from one another are electrically connected and dynamically charged in pairs, with a sinusoidally varying voltage in time such that the two pairs are always in exact opposite electrical polarity. The electrodynamic forces created on a charged particle located on or near the central axis parallel to the posts, such that the particle is stably confined to that axis. This mechanism provides the means to confine individual micron sized particles along a very narrow path. With a properly working ELQ, the particles can be held to within less than a micron along this path, as is known by those skilled in the art.

Particles that posses a surface charge that is of the same polarity as the other particles in the flow stream will naturally space themselves from their nearest neighbor along the ELQ axis due to the physical requirement that like electrical charges repel. This natural spacing allows for the viewing and illumination of individual particles by a light source.

The apparatus can be operated such that the air pressure within the ELQ is maintained in a range from low to above ambient atmospheric pressure, and the control of airflow from one end of ELQ to the other is used to push the particles through at controlled rates and velocities.

### Pre-Quadrupole Capture Particle Charging Apparatus

Particles must have a net electrical charge in order to be confined in an ELQ. There are several methods commonly used to charge particles in an air flow, and thus can be used to charge particles before putting them into an ELQ. Example methods typically used for the charging of particles in an air flow are ionic discharge systems such as boxer charger and electrospray. U.S. Pat. No. 4,414,603, issued in 1983 to Masuda et. al and U.S. Pat. No. 4,265,641, issued in 1981 to Natarajan, and U.S. Pat. No. 5,973,904 issued in 1999 to Pui et. al, describe appropriate type of charging devices that could be used to charge particles in the construction of this invention.

Another method of creating charged particles is the direct electrospraying of a liquid solution that contains the particles near or within the entrance of the quadrupole in such a way such that the particles that are sprayed become trapped within the ELQ. Electrospraying particles from a solution initially forms highly charged droplets, each containing one or more particles. The high surface charge induced on these droplets causes them to repeatedly break apart and evaporate. Particles originally contained within these droplets are left with a residual surface charge. An apparatus that also utilizes this method to charge small particles is described in patent U.S. Pat. No. 7,972,661 B2, issued in 2011 to Pui, et. al. By directly spraying such particles into an end of an ELQ a high percentage of these particles will be trapped by the ELQ.

### UV Illumination

Ultraviolet (UV) light sources come in many forms. A common UV source that is particularly useful to create the present invention is a cylindrical light bulb, which can be obtained at different lengths, intensities and wavelength ranges. Light from bulb emitters is in general broadband, that is, it contains many wavelengths of light rather than a single color. For interrogations requiring specific bands of UV, filters can be put in front of the bulbs that pass only those wavelengths, as commonly done by those skilled in the art.

Other useful sources of UV radiation are from light emitting diode (LED) and laser UV light sources. UV light emitting from a laser or LED can be more efficiently directed and focused onto single specific individual particles. Light from a laser or LED generally contains much fewer wavelengths as compared with more broad band bulb light sources, so that interrogations of particles using a specific wavelength of UV radiation would be possible without the use of filters. Also, more advanced optics can be used to direct the laser or LED light into various shapes, such as a line along the particles path, or to defocus as a control of intensity, as known by those skilled in the art.

### Interrogation for In-Line Particle Interrogation and Filtering

Combinations of laser light sources and light detectors can be used for single particle interrogation such as for particle counting, sizing and fluorescence. This type of interrogation is used to verify and quantify the presence of particles that are trapped within the quadrupole without subjecting the particles to additional UV light. As commonly performed by those skilled in the art, the method creates a beam of light from a light emitting diode (LED) or from a laser, across the path of the trapped particles within the ELQ. As the particles cross the beam they scatter the light in all directions, some of which is received by a light detector that is located just outside the ELQ between the posts, adjacent to, or in front of the light beam.

If a light beam is of high enough intensity at the point a particle crosses the beam, a force can be created that that is sufficient to push the particle away from the central axis of the ELQ causing it to be effectively lost from the ELQ trapping force. When used in conjunction with an interrogation beam, this method can be used as a filtering mechanism for particles with specific characteristics such as, but not limited to the intrinsic fluorescence, size and shape which may be undesirable for the use of the present invention.

### Reaction of In-Line Particles

Particles that are confined within the ELQ can be challenged with various reactants at various concentrations and at various durations. The particle could also be exposed to reactants and electromagnetic radiation simultaneously.

### Particle Collection Apparatus, Post-UV Illumination

After the particles pass through the UV light interrogation and to the end of the ELQ they are collected such that further interrogation can be performed. Airflow that is carrying the particles is made to pass through a filter or onto a substrate collection surface that collects the particles in such a way that the filter or collection surface, now containing the particles, can be removed so as to perform tests on the particles outside of the ELQ.

### DESCRIPTION OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description when considered in conjunction with the drawings.

FIG. 1: Diagram of the main components of the invention.

FIG. 2: The ELQ apparatus showing the electrical connections and particle collection filter. Particles flow into the top of the ELQ near the axis where they become trapped due to electromagnetic forces.

FIG. 3: Diagram showing how the UV sources are arranged along the length of the ELQ for the primary embodiment. The UV sources are arranged such that the trapped particles receive radiation as they move within the ELQ. The particle flow velocity, length and intensity of the UV bulbs determine how much radiation each particle receives.

FIG. 4: Diagram showing how particle interrogation laser sources and detectors are arranged along the length of the ELQ. A single laser/detection pair is shown at a point along the length of the ELQ. These laser sources are directed such that the beams intersect the particle flow path at the center of the ELQ. The detectors, which may be at 90 degrees or directly in front of the laser sources are used to optically interrogate particles using the scattered laser light as they flow through the ELQ. FIG. 4 shows a detector at 90 degrees from the laser source.

FIG. 5: Illustrates an in-flight filtering method that can be achieved by locating a second laser light source (L2) a known distance downstream from the first laser (L1), used as an interrogator. Instead of a filter to collect particles, a flat, conductive plate that is electrically grounded or electrostatically charged is used.

### DETAILED DESCRIPTION OF THE INVENTION

One purpose of the present invention is to supply a method, system and apparatus to illuminate small, micron (10⁻⁶ meter) size particles with controlled amounts of ultra-violet electromagnetic radiation and then to collect the particles to interrogate for possible changes, such as the ability of live organisms to survive after the illumination.

### Example 1

Particles are moved through the system using a controlled air flow, such as can be achieved using a light to moderate air pump at the back end of the system that continually pulls air through the entire system.

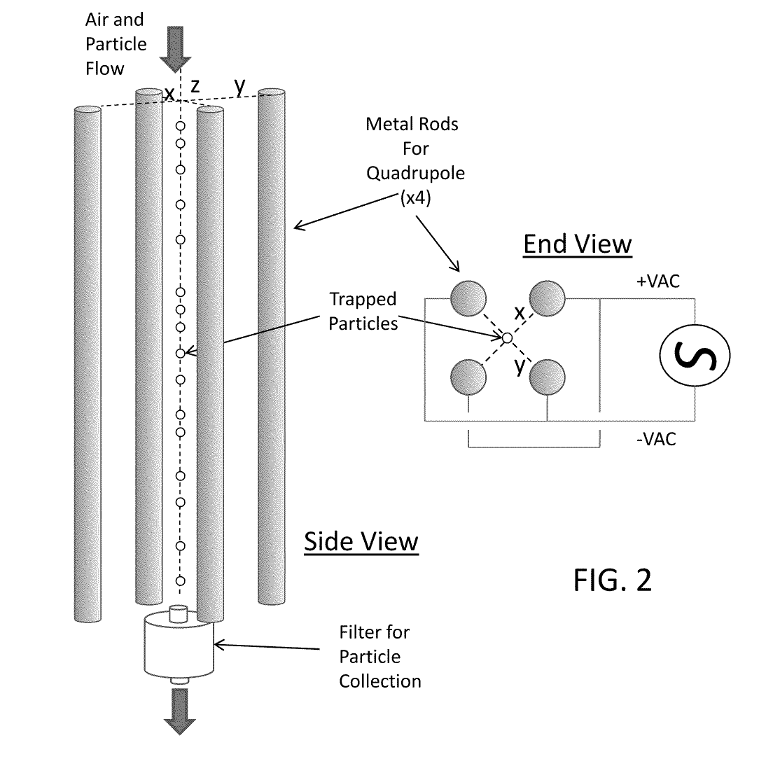

FIG. 2 shows the direction of the airflow from the top end to bottom end of the ELQ. With the use of common valves and meters, the airflow rate can be controlled, as known by those knowledgeable in the practice.

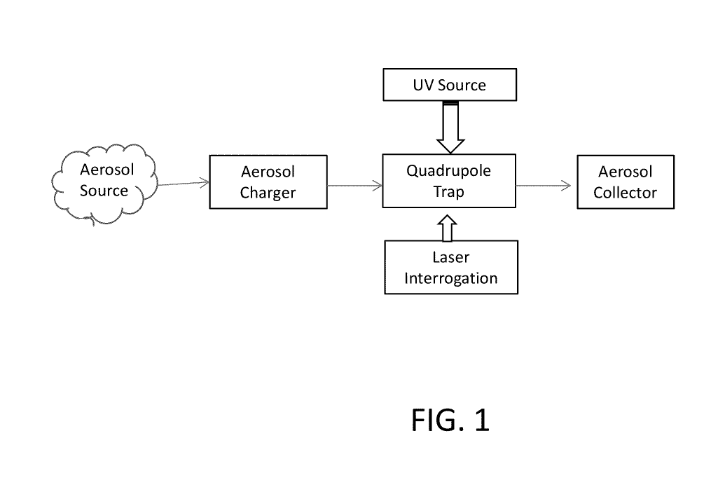

By way of the controlled airflow, particles are first taken into a charging section where they acquire a surface charge, as shown in FIG. 1. This section is located directly above the ELQ in FIG. 2, but is not shown. There are several methods by which the particle charging can be achieved as known by those familiar in the art, as described herein.

The charged particles then continue into the ELQ section where they are confined to the central axis of the ELQ, as shown in FIG. 2. Since each particle is charged with the same electrical polarity, the particles also repel one another, which naturally spaces them apart from the nearest neighboring particle while being held along the axis of the ELQ. The automatic distancing between the particles makes individual particle interrogation easier during the process of this invention.

The controlled airflow moves the particles from one end of the ELQ chamber to the other, where they are finally collected into a filter or collection surface. The filter or collection surface used in this case is such that the particles can be extracted at a later time for testing, such as for viability in the case of biological organisms, as understood by those skilled in the art of biological testing.

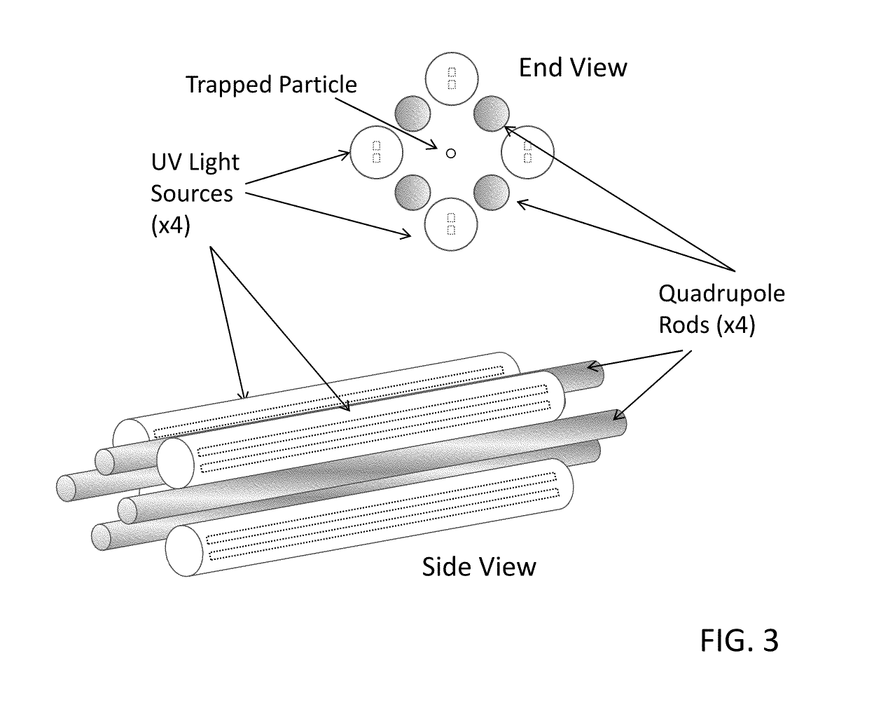

One to four cylindrically shaped light bulbs that emit UV radiation are used as a constant source of radiation along the path of the particles within the quadrupole, as shown in FIG. 3.

The length and intensity of the bulbs is a means to control how much UV radiation each particle will receive. The arrangement of the bulbs is such that the UV radiation will pass between the poles that comprise the ELQ and thus visible along the axis of the ELQ.

During the trip through the ELQ, each particle is illuminated by UV radiation produced by the UV bulbs. The speed at which the particles pass through the UV illuminated section also determines how much radiation each particle receives, and is controlled by the rate of airflow.

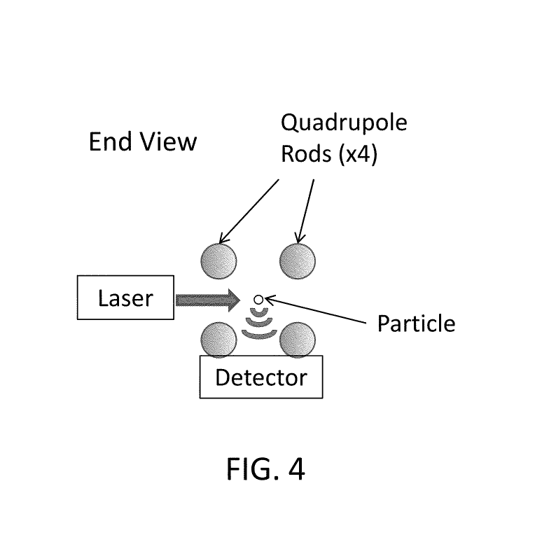

As the particles traverse the ELQ chamber, they are subjected to one or more interrogation lasers, as shown in FIG. 4. Interrogation lasers can be located above (upstream of airflow) or below (downstream to airflow) the UV radiation zone of the chamber. In cases when there is room, such as embodiments where there are only one or two UV bulbs or shorter length UV bulbs, these lasers can be placed along the path where the particles are receiving the UV radiation.

This method, system and apparatus allows for the illumination of airborne particles using UV on a single particle basis, without having to first collect them onto a substrate or into a liquid.

By illuminating the particles while in flight, the method offers a more realistic or free floating approach when quantifying the effects of UV illumination on natural aerosols, such as that which may be naturally occurring as particles suspended in the earth's atmosphere.

The particles are spatially confined by electrodynamic forces causing them to follow along the central axis of the ELQ while maintaining a distance between one another in an ambient air environment.

The present invention takes advantage of this situation to illuminate and interrogate individual particles on-the-fly, that is, before having to collect them onto a substrate or into a liquid as is commonly done by those in the field of aerosol investigations. Since more than many hundreds of particles can be passed through the system every second, the method is very rapid.

### Example 2

A further embodiment utilizes interrogation lasers along the path of the particle flow that are used as particle filters.

These lasers have enough power to push a particle far enough off the ELQ axis such that it is no longer held by the ELQ system and thus taken out of the collected sample. For instance particles may be filtered out of the flow stream based on particle parameters such as, but not limited to, morphology (size, shape, etc.) or physical properties (fluorescence, scattering, absorbance, etc).

The confinement of the particles to a well defined axis effectively cleans the sample for specific interrogations to build a statistical analysis based on single particle counts while selectively filtering the particle samples.

The main ELQ apparatus in the electronic sense, is an open circuit with a capacitance, and although voltages in the range of 1 kilovolts to 3 kilovolts are required, there is very little overall power consumption.

### Example 3

### Particle Charging

An alternative to the in-flight charging of particles is to electrospray a liquid containing previously collected particles into the airflow of the ELQ. This method would be useful to analyze previously collected aerosol samples since the aerosol collectors that place the particles into a liquid solution are already commonly used in the field of aerosol sampling and collection.

### Example 4

### UV Illumination

Instead of rod shaped UV lights, UV radiation is from a laser or set of lasers that emit light at UV wavelengths. Speed of the particles and spot size of UV laser illumination determine how long each particle is illuminated by the UV radiation.

### Example 5

### Electromagnetic Illumination (Visible, IR, Microwave)

Another possible embodiment is to employ various wavelengths other than UV to investigate particle reaction behavior over a broader range of EM frequency. The photons can be utilized as a reactant or catalysis to obtain photochemical reaction.

### Example 6

### Particle In-Flight Filtering Using a Laser

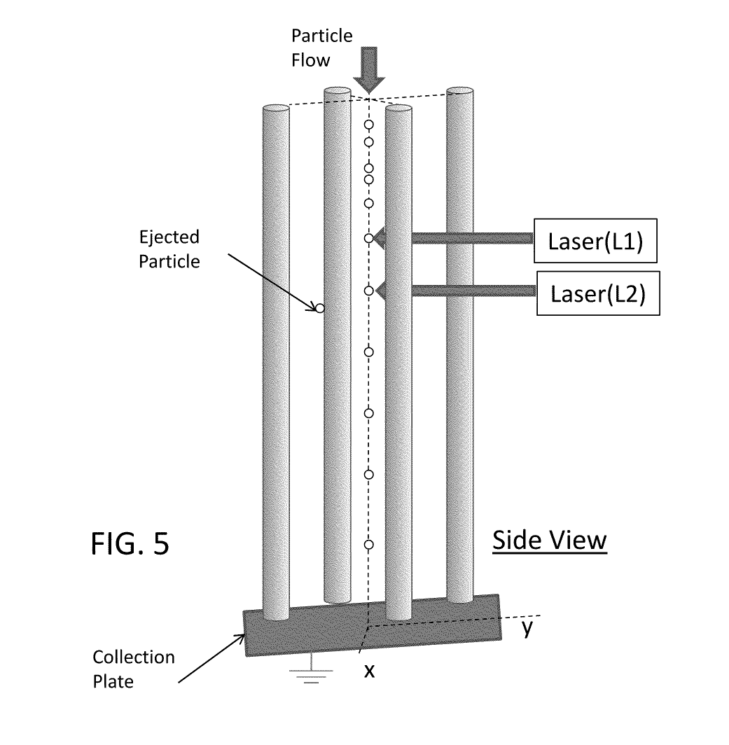

It is also possible to collect a more specific subset of particles, such that a means to eliminate undesired particles from the sample is desired. An in-flight filtering method can be achieved by locating a second laser light source (L2) a known distance downstream from the first laser (L1), used as an interrogator, as shown in FIG. 5.

Depending on the outcome of the laser interrogation of L1, L2 is used to deflect the particle off of the quadrupole axis by supplying a sudden pulse of light with enough energy to push the particle from the ELQ axis, and thus removing it from the collected set of particles.

Several pairs of such lasers can be directed along the path of the particles within the ELQ, and can vary in wavelength depending on the need of different wavelengths as dictated by the filtering requirements. In this embodiment the laser beam (L1) also serves as a trigger for the second laser source (L2) for the timing of the particle ejecting pulse.

It is also possible to use the same laser beam (L1) as the detection/interrogation and ejector if fast enough electronics are used and the laser is capable of quickly changing power output, such that a single particle is first interrogated by the laser in low power mode, followed by fast decision making electronics and then subsequently ejected by the same laser using a higher power pulse of short duration, all before the particle has a chance to flow out of the laser beam (L1) influence. This is achievable using existing technology for time scales on the order of milliseconds (0.001 sec) which is appropriate for typical particle flow rates within an ELQ.

### Example 7

### Particle Collection

Instead of a filter to collect particles, a flat, conductive plate that is electrically grounded or electrostatically charged is used as shown in FIG. 5. The plate is charged such that it is at the opposite electrical potential as the particles. This causes the particles to be electrostatically attracted to the surface of the plate, where they stick and are later collected from. The plate may consist of only a small area that is conductive such that the collected particles collect onto a more specific collection location.

### Example 8

A flat, nonconductive plate with an array of conductive spots on the surface, with each of the conductors grounded or charged to a potential opposite of the charged particles, such that the particles are attracted to the conductive spots on the plate.

### Example 9

The area of collection is located on an X-Y translation that can be moved by automation or by hand to collect particles for certain amounts of time, then moved, creating an array of particle spots on a plate. This apparatus can translate the plate linearly or rotate the plate such that the particles will tend to impact on a different position on the charged plate when desired. This is particularly useful when using a plate with an array of conductive spots.

The above examples are merely illustrative of several possible embodiments of various aspects of the present disclosure, wherein equivalent alterations and/or modifications will occur to others skilled in the art upon reading and understanding this specification and the annexed drawings. In addition, although a particular feature of the disclosure may have been illustrated and/or described with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

What we claim is:

1. A method of illuminating individual particles comprising:
moving and directing air containing particles into a system comprising an electrodynamic linear quadrupole section;
controlling the air flow by using an air pump that continuously pulls or pushes air through the system;
directing the particles into the electrodynamic linear quadrupole section;
confining the particles to the central axis of the electrodynamic linear quadrupole section;
illuminating the particles with ultra-violet electromagnetic radiation;
interrogating the particles; and
collecting the particles.

2. The method of illuminating individual particles of claim 1 further comprising the step of charging the particles prior to or during the step of directing the particles into the electrodynamic linear quadrupole section.

3. The method of illuminating individual particles of claim 2 further comprising the step of using one to four cylindrically shaped light bulbs that emit UV radiation as a constant source of radiation along the path of the particles within the electrodynamic linear quadrupole section.

4. The method of illuminating individual particles of claim 3 wherein the step of interrogating the particles is via a laser.

5. The method of illuminating individual particles of claim 4 wherein the illumination of particles is on a single particle basis without having to first collect them onto a substrate or into a liquid.

6. The method of illuminating individual particles of claim 1 wherein the step of interrogating the particles is via a laser and wherein the interrogating is on the basis of particle counting, sizing or fluorescence.

7. The method of illuminating individual particles of claim 1 further including the steps of:
projecting a beam of light from a light emitting diode or from a laser across a path of the particles within the electrodynamic linear quadrupole section thereby scattering light; and
receiving the light via a light detector.

8. The method of illuminating individual particles of claim 1 further including the step of projecting a beam of light across a path of the particles within the electrodynamic linear quadrupole section and thereby causing a particle to be ejected from the electrodynamic linear quadrupole section and thereby filtering the particles based on intrinsic fluorescence, size or shape.

9. An apparatus for illuminating individual particles comprising:
a device for moving and directing air containing particles into a system;
the system comprising an electrodynamic linear quadrupole section;
an ultra-violet electromagnetic radiation source located along the electrodynamic linear quadrupole section; and
a collection device for collecting the particles.

10. The apparatus for illuminating individual particles of claim 9 further comprising:
a laser source for interrogating the particles.

11. The apparatus for illuminating individual particles of claim 10 wherein the ultra-violet electromagnetic radiation source is a UV light or a laser that emits light at UV wavelengths.

12. The apparatus for illuminating individual particles of claim 11 wherein the collection device for collecting the particles is a filter or a conductive plate that is electrically grounded or electrostatically charged either in whole or in sections.
